(19) United States
(12) Patent Application Publication
(10) Pub. No.: US 2015/0170243 A1
(43) Pub. Date: Jun. 18, 2015

(54) CREATING A HOUSE OF QUALITY FOR PRODUCT DESIGN

(71) Applicant: International Business Machines Corporation, Armonk, NY (US)

(72) Inventors: Miao He, Beijing (CN); Jinfeng Li, Beijing (CN); Fei Liu, Beijing (CN); Tao Qin, Beijing (CN); Changrui Ren, Beijing (CN); Bing Shao, Beijing (CN)

(73) Assignee: International Business Machines Corporation, Armonk, NY (US)

(21) Appl. No.: 14/105,651

(22) Filed: Dec. 13, 2013

(51) Int. Cl. G06Q 30/06

(52) U.S. Cl. CPC G06Q 30/0621

(57) ABSTRACT

A method of creating a House of Quality for product design, the House of Quality including a plurality of customer requirements, each of which has corresponding requirement importance includes obtaining a plurality of customer comments on a product; determining, with a processing unit hot words from each of the customer comments, determining at least one customer requirement associated with the each of the comments and assessment rating for that customer requirement based on the hot words; and determining requirement importance of each of the customer requirements.

### BACKGROUND

The present invention relates generally to computer data processing and, more particularly, to a method and apparatus of creating a House of Quality for product design.

### BACKGROUND

House of Quality (HoQ) is a method of illustration, which resembles a house and is widely used in manufacturing industry. HoQ originally appeared in 1972 and is a significant part of Quality Function Deployment (QFD). HoQ is mainly used to define relationships between customer requirements and technical solutions.

Referring to FIG. 2, which shows the structure of an existing HoQ by taking a refrigerator for example, for a plurality of customer requirements (such as, noise, frosting, heat dissipation and the like), score of customer's several customer requirements on the refrigerator may be obtained by manner of market survey, so that requirement importance of each customer requirement may be further determined. A matrix portion in the HoQ shown in FIG. 2 represents association relationships between each technical solution (TR1, TR2, . . . TR6) and each customer requirement, the circle, square and other symbols therein represent different association degree. A “roof” portion represents associations among different technical solutions. Moreover, the HoQ also has other portions; however, these other portions are not directly associated with that to be improved by the present application, and are also known to those skilled in the art, the description of which will be omitted here for brevity.

In prior art, a customer's assessment rating on respective customer requirement is mainly obtained by face-to-face survey, so that requirement importance of each customer requirement is determined. Thus, it has following drawbacks: judgment of those polled may be affected by surveyors; a large amount of human power, material resources are wasted in face-to-face survey, face-to-face survey only involves a few samples; face-to-face survey has long cycle and can not be updated in time.

Therefore, although the existing HoQ has been used for more than 40 years, it still needs to be improved in a large data era.

### SUMMARY

A method of creating a House of Quality for product design, the House of Quality including a plurality of customer requirements, each of which has corresponding requirement importance includes obtaining a plurality of customer comments on a product; determining, with a processing unit hot words from each of the customer comments, determining at least one customer requirement associated with the each of the comments and assessment rating for that customer requirement based on the hot words; and determining requirement importance of each of the customer requirements.

In another embodiment, an apparatus is disclosed for creating a House of Quality for product design, the House of Quality including a plurality of customer requirements, each of which has corresponding requirement importance. The apparatus includes an obtaining means configured to obtain a plurality of customer comments on a product; a determining means configured to determine hot words from each of the customer comments, determine at least one customer requirement associated with the each of the comments and assessment rating for that customer requirement based on the hot words; and a calculating means configured to calculate requirement importance of each of the customer requirements.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a diagram of an exemplary computer system/server which is applicable to implement the embodiments of the present invention;

FIG. 2 shows an example of a House of Quality (HoQ) in prior art;

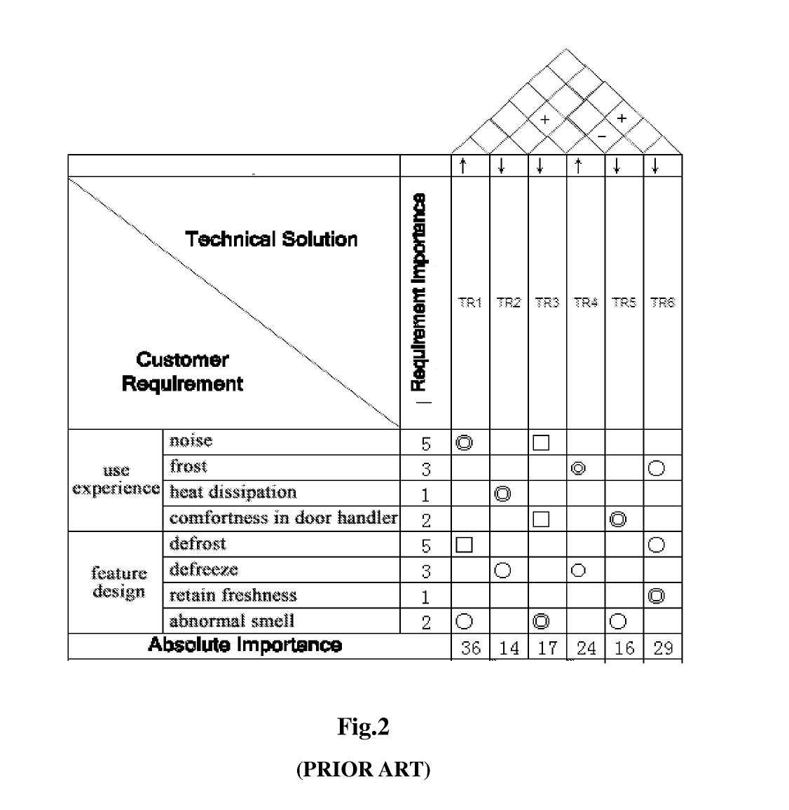

FIG. 3 shows a flowchart of a method for creating a HoQ according to an embodiment of the present invention;

FIG. 4 shows an embodiment of block 320 in FIG. 3;

FIG. 5 shows a flowchart of a method for obtaining hot words associated with respective customer requirements through machine learning according to an embodiment of the present invention;

FIG. 6 shows a flowchart of a method of how to determine at least one customer requirement associated with each of customer comments and assessment rating for that customer requirement based on the hot words according to an embodiment of the present invention;

FIG. 7 shows a flowchart of a method of determining requirement importance of that customer requirement based on statistic value of assessment rating of that customer requirement and hot degree of assessment of that customer requirement according to an embodiment of the present invention;

FIG. 8 shows an illustrative block diagram of an apparatus of creating a House of Quality according to an embodiment of the present invention.

### DETAILED DESCRIPTION

According to an aspect of the present invention, there is provided a method of creating a House of Quality for product design, the House of Quality including a plurality of customer requirements, each of which has corresponding requirement importance, the method comprising: obtaining a plurality of customer comments on a product; determining hot words from each of the customer comments, determining at least one customer requirement associated with the each of the comments and assessment rating for that customer requirement based on the hot words; determining requirement importance of each of the customer requirements.

According to another aspect of the present invention, there is provided an apparatus of creating a House of Quality for product design, the House of Quality including a plurality of customer requirements, each of which has corresponding requirement importance, the apparatus comprising: an obtaining means configured to obtain a plurality of customer comments on a product; a determining means configured to determine hot words from each of the customer comments, determine at least one customer requirement associated with the each of the comments and assessment rating for that customer requirement based on the hot words; a calculating means configured to calculate requirement importance of each of the customer requirements.

With the technical solution of the present application, a House of Quality may be effectively created.

Exemplary embodiments will be described in more detail with reference to the accompanying drawings, in which the embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

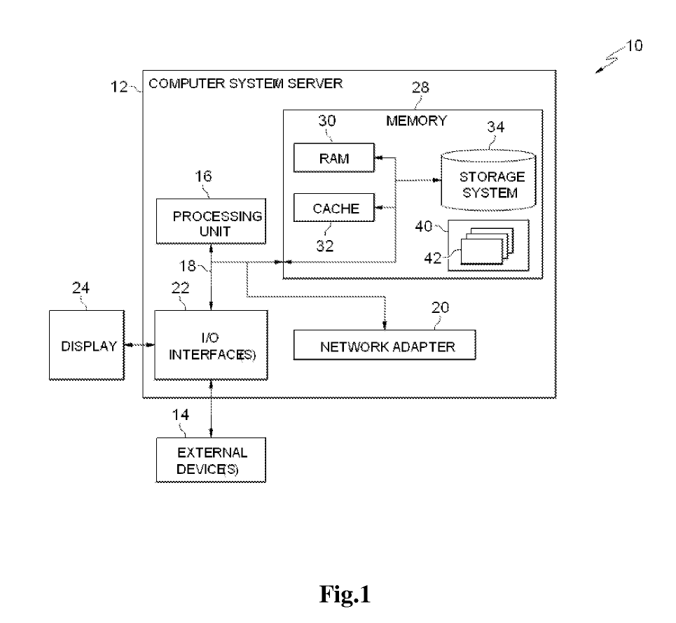

Referring now to FIG. 1, there is shown a diagram of an exemplary computer system/server 12 which is applicable to implement the embodiments of the present invention. Computer system/server 12 is only illustrative and is not intended to suggest any limitation as to the scope of use or functionality of embodiments of the present invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the present invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

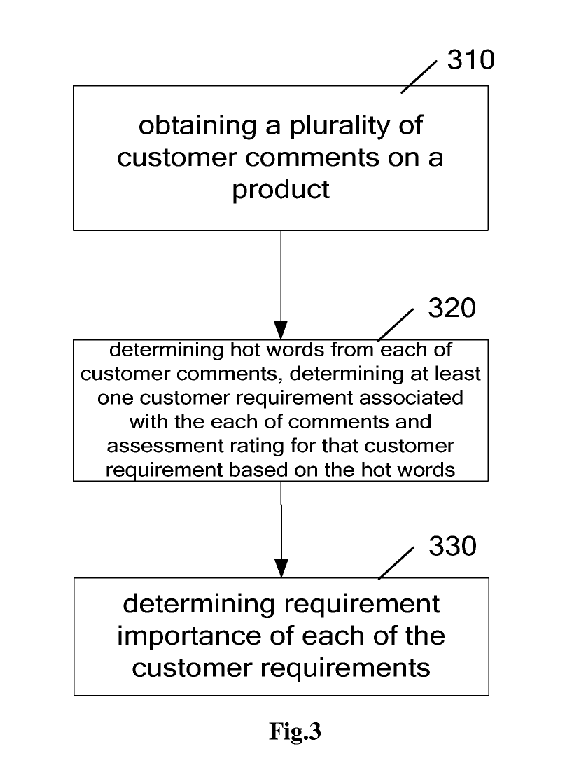

Referring now to FIG. 3, a flowchart of a method for creating a HoQ according to an embodiment of the present invention is shown. The HoQ includes a plurality of customer requirements, each of which represents a type of customer requirement, wherein, each of the customer requirements has corresponding importance of customer requirements, the method comprises the following operations.

At block 310, a plurality of customer comments on a product are obtained. The customer comments may be various information from network, and mainly are various voices of customer for a certain product, such as, product consults, product comments (such as a comment made by user A: noise of refrigerator is very big) and the like. A large amount of customer comments about a certain product may be obtained from various electronic business websites. The data obtained in this step is massive unstructured textual data, and is substantially different from existing survey data obtained via a survey in terms of data wideness and data amount.

At block 320, the method determines hot words from each of the customer comments, and determines at least one customer requirement associated with the each of the comments and assessment rating for that customer requirement based on the hot words. An assessment rating of a customer requirement has at least one hot word associated therewith. Since the number of customer requirements is very large, a customer rarely makes comment on all customer requirements within one piece of comment. Thus, in this step, for each piece of comment, what is needed is to just determine at least one customer requirement associated with that comment.

Assessment rating reflects a customer's subjective feeling on a customer requirement, and can quantify customer's subjective assessment on that customer requirement. Different assessment ratings may be represented in various ways, such as “positive”, “negative” or “good”, “medium”, “poor”, or be represented with a specific score table, such as three-grade, five-grade, and hundred-grade marking system.

At block 330, requirement importance of each of the customer requirements is determined. The importance of customer requirement reflects importance degree of that customer requirement for the customer. In an embodiment, for each of the customer requirements, the requirement importance of that customer requirement is determined based on a statistic value of at least one assessment rating of that customer requirement. The statistic value may be sum, average value, weighted average value, etc. In a specific example, average value is used for explanation. It is assumed the assessment rating of a customer for low noise is 5 points, which indicates that the customer thinks noise is very low. If, among 10 customers, the assessment rating of 6 customers is 5 points and the assessment rating of 4 customers is 1 point, then the importance of that customer requirement is (6×5)+(4×1)/10=3.4.

In another embodiment, for each of the customer requirements, requirement importance of that customer requirement is determined based on statistic value of at least one assessment rating of that customer requirement and hot degree of assessment of that customer requirement. The requirement importance may be determined through sum, weighted average value of statistic value and hot degree of assessment etc. Hereinafter, the applicant will described this embodiment in detail.

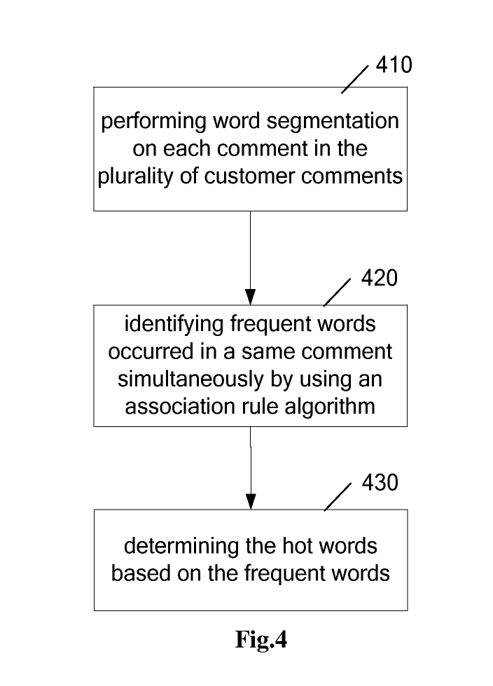

FIG. 4 shows an embodiment of step 320 in FIG. 3.

At step 410, word segmentation is performed on each comment in the plurality of customer comments. All customer comments may be scanned against a given dictionary and word segmentation is then performed thereon. Once segmentation is done, each comment may be represented with a series of segmented words. For example, “the refrigerator is good at retaining freshness at zero degrees->refrigerator/zero degree/retain freshness/good”.

In a more specific embodiment, a maximum matching segmentation method is used for word segmentation, which may comprise: assume number of Chinese characters contained within the longest entry in an automatic word segmentation dictionary is i, then the first i characters in current character sequence of a comment being processed is taken as matching field so as to lookup in the word segmentation dictionary; if there is such an i-character word in the dictionary, then matching succeeds and the matching field is segmented out as a word; if such an i-character word could not be found in the dictionary, then matching fails, the last Chinese character is removed from the matching field, and matching is performed again by using the remaining characters as a new matching field; these steps are repeated until matching is successful.

At step 420, for comments on which word segmentation has been performed, frequent words occurring in a same comment simultaneously are identified by using an association rule algorithm. In a specific embodiment, the employed association rule algorithm is a priori algorithm. When number of times a plurality of words having association determined via the association rule algorithm occurs in all comments exceeds a threshold, the words are considered as frequent words. By way of example, comment of customer 1 is “the refrigerator is good at refrigeration”, comment of customer 2 is “that model is very good at refrigeration”, then there are two customers who have mentioned “refrigeration” and “good” simultaneously. Since there are more than two (other set number is also possible) customers who have mentioned “refrigeration” and “good” simultaneously, they may be considered as frequent words.

At step 430, the hot words are determined based on the frequent words. In an embodiment, frequent words may be directly selected as the hot words. In another embodiment, frequent words may also be combined into new hot words, particularly, if spacing between words where frequent words occur is less than a predetermined value, these words are considered as hot words. As in the above example, in comment of customer 1, spacing between “refrigeration” and “good” is 1; while in comment of customer 2, spacing between “refrigeration” and “good” is 1. When the predetermined value is set as 3 characters, “good at refrigeration” becomes hot words.

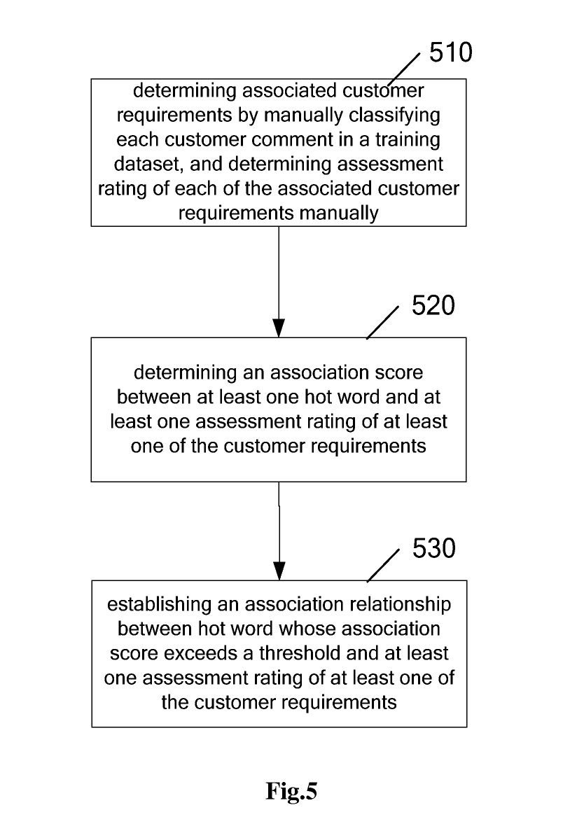

FIG. 5 shows a flowchart of a method for obtaining hot words associated with respective customer requirements through machine learning according to an embodiment of the present invention. With the flow shown in FIG. 5, hot words most relevant to the topic may be extracted for each of the customer requirements in the HoQ.

At step 510, associated customer requirements are determined by manually classifying each customer comment in a training dataset, and determining assessment rating of each of the associated customer requirements manually. The training dataset is a plurality of customer comments on a product for machine learning. By way of example, the comment of customer 1 is “the refrigerator has low noise, large volume and nice look”, then result of manual and subjective classification is: customer requirements involved in this comment are “noise”, “volume” and “look” respectively, and assessment rating of “noise” is ‘positive’, assessment rating of “volume” is ‘positive’, and assessment rating of “look” is ‘positive’.

At step 520, an association score between at least one hot word and at least one assessment rating of at least one of the customer requirements is determined. Association score between each hot word and each assessment rating of each customer requirement may be determined. In a more specific embodiment, association score between each hot word and each assessment rating of each customer requirement is calculated by using a Logistic Regression algorithm based on the training dataset, result of manual classification and the manually determined assessment rating.

The following is an exemplary flow of Logistic Regression algorithm:

First, the following definitions are provided:

Xᵢⱼ represents whether each hot word j appears in comment of customer i, Xᵢⱼ=1 represents yes, Xᵢⱼ=0 represents no;

yᵢ represents whether comment of customer i belongs to an assessment rating of a certain customer requirement (positive/negative), yᵢ=1 represents yes, yᵢ=0 represents no;

Xₖ represents whether hot word k appears, Xₖ=1 represents yes, Xₖ=0 represents no;

βₖ represents coefficient of regression;

P represents probability that a certain comment belongs to assessment rating (positive/negative) of a certain customer requirement, 1-P represents probability that a certain comment does not belong to assessment rating (positive) of a certain customer requirement.

Then, ratio of event occurrence is represented with the following logistic regression model:

$$ln \frac{p}{1 - p} = log it ( p ) = {β}_{0} + {β}_{1} {X}_{1} + {β}_{2} {X}_{2} + … + {β}_{k} {X}_{k}$$

Next, value of βₖ is determined by training data, specifically, maximum likelihood estimation method may be used for training n samples, and proper β₀, β₁, β₂, . . . βₖ are selected, such that value of InL is maximized.

$$L = {\prod }_{i = 1}^{n} [ {y}_{i} ( {β}_{0} + {β}_{1} {X}_{i 1} + {β}_{i 2} {X}_{2} + … + {β}_{k} {X}_{ik} ) - ln ( 1 + {e}^{{β}_{0} + {β}_{1} {X}_{i 1} + {β}_{i 2} {X}_{2} + … + {β}_{k} {X}_{ik}} ) ]$$

$$ln L = {\sum }_{i = 1}^{n} [ {y}_{i} ( {β}_{0} + {β}_{1} {x}_{i 1} + {β}_{2} {x}_{i 2} + … + {β}_{k} {x}_{ik} ) - ln ( 1 + \text{?} ) ]$$

$$\text{?} \text{indicates text missing or illegible when filed}$$

Finally, the Wald verification equation Wk, [βₖ/SE(βₖ)]² is used to perform confidence validation on βₖ, in which SE(βₖ) is standard error of βₖ, Wald statistic follows such a λ² distribution whose degree of freedom equals to 1, and confidence probability of βₖ is used to represent association score between a certain hot word and an assessment rating of a certain customer requirement. The applicant merely introduces the general flow of logistic regression algorithm; however, its specific details will be omitted for brevity since the logistic regression algorithm is a machine learning method known to those skilled in the art.

By way of example, hot words extracted through hot word mining comprise: “large noise” “large sound”, “high noise”, “low noise”, “poor heat dissipation”, “fine look”, “large volume”, “good refrigeration effect”; association score between each hot word and noise (noise) (negative) is calculated by using a logistic regression method (value is between 0-1, 0: most irrelevant, 1: most relevant); analysis result is that association score between hot word “large noise” and noise (negative) is 0.96; association score between “large sound” and noise (negative) is 0.95; association score between “high noise” and noise (negative) is 0.97; association score between “low noise” and noise (negative) is 0.01; association score between “poor heat dissipation” and noise (negative) is 0.05; association score between “fine look” and noise (negative) is 0.04; association score between “large volume” and noise (negative) is 0.02; and association score between “good refrigeration effect” and noise (negative) is 0.02.

At block 530, an association relationship is established between hot word whose association score exceeds a threshold and at least one assessment rating of at least one of the customer requirements. The hot words whose association score exceeds a threshold may be judged as hot words associated with the assessment rating of the customer requirement, thereby establishing association relationship. In an embodiment, for at least one assessment rating (positive/negative) of each customer requirement, hot words whose association score exceeds a threshold are judged as hot words associated with at least one assessment rating (positive/negative) of that customer requirement. For example, in the example of block 520, the threshold is set as 0.95, then hot words having association relationship with noise (negative) are “large noise”, “large sound”, “high noise”; thus, the association relationship between noise (negative) and the three hot words are established.

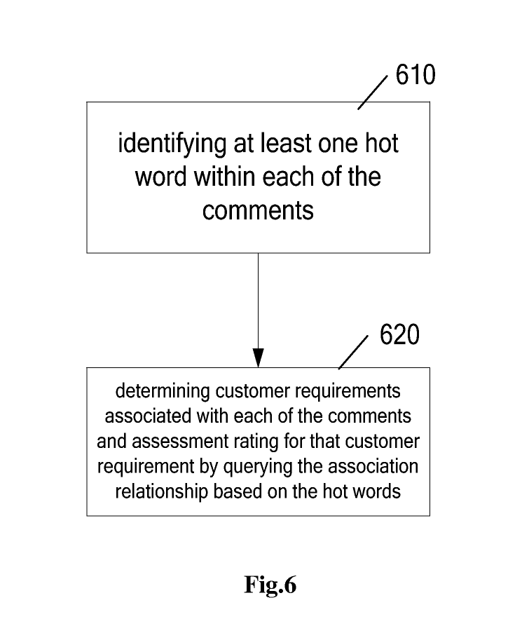

FIG. 6 shows a flowchart of a method of how to determine at least one customer requirement associated with each of customer comments and assessment rating for that customer requirement based on the hot words according to an embodiment of the present invention. Each of customer comments may be classified by a machine and assessment rating thereof may be determined, which comprises the following steps.

At block 610, at least one hot word is identified within each of the customer comments. Hot words appeared in each of the comments may be identified by using character matching rule.

At block 620, customer requirements associated with each of the customer comments and assessment rating for that customer requirement are determined by querying the association relationship based on the hot words. Assessing rating (positive/negative) of customer requirements to which the hot word belongs is queried, so that each of the comments may be classified by a machine and assessment rating thereof may be determined. For example, the comment of customer 3 is “the refrigerator has large noise”, hot word “large noise” appeared in that comment; by querying the association relationship, it may be known that customer requirement to which the hot word “large noise” belongs is “noise” and assessment rating is ‘negative’, such that customer requirement and assessment rating corresponding to this comment of customer 3 may be determined.

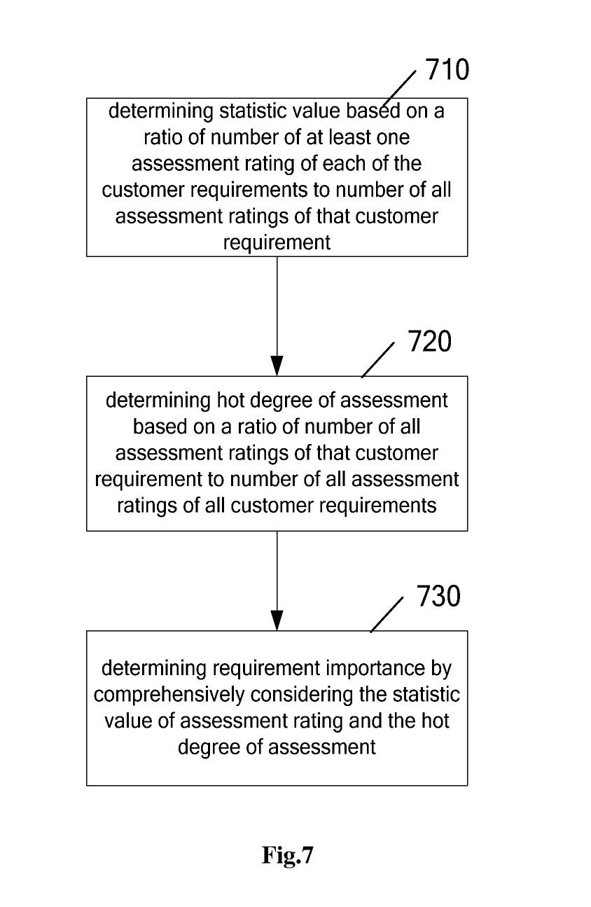

FIG. 7 shows a flowchart of a method of determining requirement importance of that customer requirement based on statistic value of assessment rating of that customer requirement and hot degree of assessment of that customer requirement according to an embodiment of the present invention.

At block 710, the statistic value based on a ratio of number of at least one assessment rating of each of the customer requirements to number of all assessment ratings of that customer requirement is determined. At block 720, the hot degree of assessment based on a ratio of number of all assessment ratings of that customer requirement to number of all assessment ratings of all customer requirements is determined.

At block 730, the requirement importance is determined by comprehensively considering the statistic value of assessment rating and the hot degree of assessment. This step may be performed in various ways, for example, the statistic value and hot degree of assessment are summed, averaged, and may also be averaged after being assigned different weights, as long as the statistic value of assessment rating and the hot degree of assessment are simultaneously taken into consideration, and other implementations will also be readily occurred to those skilled in the art.

Next, the applicant will describe this embodiment with two equations (equation 1, equation 2).

According to equation 1, requirement importance

$$= \frac{Neg ( i )}{Pos ( i ) + Neg ( i ) + Neut ( i )} + α exp \frac{Pos ( i ) + Neg ( i ) + Neut ( i )}{{\sum }_{i}^{ } Pos ( i ) + {\sum }_{i}^{ } Neut ( i ) + {\sum }_{i}^{ } Neg ( i )}$$

According to equation 2, requirement importance

$$= \frac{Neg ( i )}{Pos ( i ) + Neg ( i ) + Neut ( i )} + α log \frac{Pos ( i ) + Neg ( i ) + Neut ( i )}{{\sum }_{i}^{ } Pos ( i ) + {\sum }_{i}^{ } Neut ( i ) + {\sum }_{i}^{ } Neg ( i )}$$

In this embodiment, for customer requirement i, there are three different assessment ratings, wherein Pos(i) represents number of assessment whose assessment rating for customer requirement i is ‘positive’, Neg(i) represents number of assessment whose assessment rating for customer requirement i is ‘negative’, and Neut(i) represents number of assessment whose assessment rating for customer requirement i is ‘neutral’. Thus, Pos(i)+Neg(i)+Neut(i) represents total number of various assessment ratings among all customer comments for customer requirement i.

In embodiments according to equations 1 and 2, for customer requirement i, a ratio of number of negative assessment ratings of a customer for that customer requirement to number of all assessment ratings for that customer requirement may be taken as the above statistic value, and this statistic value represents dissatisfaction rate. Meanwhile, hot degree of that customer requirement is also taken into consideration, that is, the hot degree of assessment is determined according to a ratio of number of all assessment ratings for that customer requirement i to number of all assessment ratings of all customer requirements.

An adjustment coefficient α is also included in equations 1 and 2, and specific value thereof may be set by those skilled in the art as needed. The equation 2 only differs from the equation 1 in that: different functions are employed in calculating hot degree of requirement.

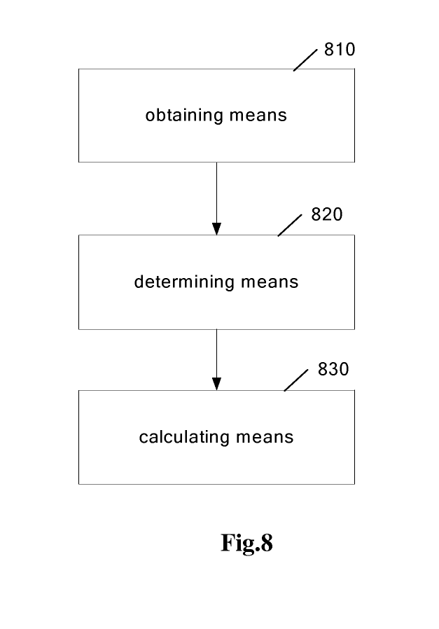

FIG. 8 shows an illustrative block diagram of an apparatus of creating a House of Quality according to an embodiment of the present invention. There is provided an apparatus of performing product design by applying a House of Quality, the House of Quality including a plurality of customer requirements, each of which has corresponding requirement importance, the apparatus includes: an obtaining means 810 configured to obtain a plurality of customer comments on a product; a determining means 820 configured to determine hot words from each of the customer comments, determine at least one customer requirement associated with the each of the comments and assessment rating for that customer requirement based on the hot words; a calculating means 830 configured to calculate requirement importance of each of the customer requirements.

In an embodiment, the apparatus further includes means configured to determine, for each of the customer requirements, requirement importance of that customer requirement based on statistic value of at least one assessment rating of that customer requirement and hot degree of assessment of that customer requirement.

In another embodiment, the apparatus further includes means configured to determine, for each of the customer requirements, requirement importance of that customer requirement based on statistic value of at least one assessment rating of that customer requirement.

In another embodiment, wherein the means configured to determine, for each of the customer requirements, requirement importance of that customer requirement based on statistic value of at least one assessment rating of that customer requirement and hot degree of assessment of that customer requirement further comprises: means configured to determine the statistic value based on a ratio of number of at least one assessment rating of each of the customer requirements to number of all assessment ratings of that customer requirement; means configured to determine the hot degree of assessment based on a ratio of number of all assessment ratings of that customer requirement to number of all assessment ratings of all customer requirements; means configured to determine the requirement importance by comprehensively considering the statistic value of assessment rating and the hot degree of assessment.

In an embodiment, the determining means 820 includes means configured to perform word segmentation on each comment in the plurality of customer comments; means configured to identify frequent words occurred in a same comment simultaneously by using an association rule algorithm; means configured to determine the hot words based on the frequent words.

In another embodiment, the apparatus further includes means configured to determine associated customer requirements for each customer comment in a training dataset manually, and determine assessment rating of each of the associated customer requirements manually; means configured to determine an association score between at least one hot word and at least one assessment rating of at least one of the customer requirements; means configured to establish an association relationship between hot word whose association score exceeds a threshold and at least one assessment rating of at least one of the customer requirements.

In an embodiment, the means configured to determine at least one customer requirement associated with the each of the comments and assessment rating for that customer requirement based on the hot words comprises: means configured to identify at least one hot word within each of the customer comments; means configured to determine customer requirements associated with each of the customer comments and assessment rating for that customer requirement by querying the association relationship based on the hot words.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of creating a House of Quality for product design, the House of Quality including a plurality of customer requirements, each of which has corresponding requirement importance, the method comprising:
obtaining a plurality of customer comments on a product;
determining, with a processing unit hot words from each of the customer comments, determining at least one customer requirement associated with the each of the comments and assessment rating for that customer requirement based on the hot words; and
determining requirement importance of each of the customer requirements.

2. The method according to claim 1, further comprising:
determining, for each of the customer requirements, requirement importance of that customer requirement based on statistic value of at least one assessment rating of that customer requirement and hot degree of assessment of that customer requirement.

3. The method according to claim 1, further comprising:
determining, for each of the customer requirements, requirement importance of that customer requirement based on statistic value of at least one assessment rating of that customer requirement.

4. The method according to claim 2, wherein determining requirement importance of that customer requirement based on statistic value of at least one assessment rating of that customer requirement and hot degree of assessment of that customer requirement comprises:
determining the statistic value based on a ratio of number of at least one assessment rating of each of the customer requirements to number of all assessment ratings of that customer requirement;
determining the hot degree of assessment based on a ratio of number of all assessment ratings of that customer requirement to number of all assessment ratings of all customer requirements;
determining the requirement importance by comprehensively considering the statistic value of assessment rating and the hot degree of assessment.

5. The method according to claim 1, wherein determining hot words from each of the customer comments comprises:
performing word segmentation on each comment in the plurality of customer comments;
identifying frequent words occurred in a same comment simultaneously by using an association rule algorithm;
determining the hot words based on the frequent words.

6. The method according to claim 1, further comprising:
determining associated customer requirements for each customer comment in a training dataset manually, and determining assessment rating of each of the associated customer requirements manually;
determining an association score between at least one hot word and at least one assessment rating of at least one of the customer requirements;
establishing an association relationship between hot word whose association score exceeds a threshold and at least one assessment rating of at least one of the customer requirements.

7. The method according to claim 6, wherein, determining at least one customer requirement associated with the each of the comments and assessment rating for that customer requirement based on the hot words comprises:
identifying at least one hot word within each of the customer comments;
determining customer requirements associated with each of the customer comments and assessment rating for that customer requirement by querying the association relationship based on the hot words.

8. An apparatus for creating a House of Quality for product design, the House of Quality including a plurality of customer requirements, each of which has corresponding requirement importance, the apparatus comprising:
an obtaining means configured to obtain a plurality of customer comments on a product;
a determining means configured to determine hot words from each of the customer comments, determine at least one customer requirement associated with the each of the comments and assessment rating for that customer requirement based on the hot words; and
a calculating means configured to calculate requirement importance of each of the customer requirements.

9. The apparatus according to claim 8, further comprising:
means configured to determine, for each of the customer requirements, requirement importance of that customer requirement based on statistic value of at least one assessment rating of that customer requirement and hot degree of assessment of that customer requirement.

10. The apparatus according to claim 8, further comprising:
means configured to determine, for each of the customer requirements, requirement importance of that customer requirement based on statistic value of at least one assessment rating of that customer requirement.

11. The apparatus according to claim 9, wherein the means configured to determine, for each of the customer requirements, requirement importance of that customer requirement based on statistic value of at least one assessment rating of that customer requirement and hot degree of assessment of that customer requirement further comprises:
means configured to determine the statistic value based on a ratio of number of at least one assessment rating of each of the customer requirements to number of all assessment ratings of that customer requirement;
means configured to determine the hot degree of assessment based on a ratio of number of all assessment ratings of that customer requirement to number of all assessment ratings of all customer requirements;
means configured to determine the requirement importance by comprehensively considering the statistic value of assessment rating and the hot degree of assessment.

12. The apparatus according to claim 8, wherein the determining means comprises:
means configured to perform word segmentation on each comment in the plurality of customer comments;
means configured to identify frequent words occurred in a same comment simultaneously by using an association rule algorithm;
means configured to determine the hot words based on the frequent words.

13. The apparatus according to claim 8, further comprising:
means configured to determine associated customer requirements for each customer comment in a training dataset manually, and determine assessment rating of each of the associated customer requirements manually;
means configured to determine an association score between at least one hot word and at least one assessment rating of at least one of the customer requirements;
means configured to establish an association relationship between hot word whose association score exceeds a threshold and at least one assessment rating of at least one of the customer requirements.

14. The apparatus according to claim 13, wherein, the means configured to determine at least one customer requirement associated with the each of the comments and assessment rating for that customer requirement based on the hot words comprises:
means configured to identify at least one hot word within each of the customer comments;
means configured to determine customer requirements associated with each of the customer comments and assessment rating for that customer requirement by querying the association relationship based on the hot words.
